(19) United States
(12) Patent Application Publication
(10) Pub. No.: US 2020/0220390 A1
(43) Pub. Date: Jul. 9, 2020

(54) POWER TRANSMISSION SYSTEM, POWER RECEIVER, AND METHOD OF CONTROLLING POWER RECEIVER

(71) Applicant: FUJITSU LIMITED, Kawasaki-shi (JP)

(72) Inventor: Akiyoshi Uchida, Akashi (JP)

(73) Assignee: FUJITSU LIMITED, Kawasaki-shi (JP)

(21) Appl. No.: 16/824,806

(22) Filed: Mar. 20, 2020

Related U.S. Application Data
(63) Continuation of application No. PCT/JP2017/034727, filed on Sep. 26, 2017.

(51) Int. Cl. H02J 50/60; H04B 5/00; H02J 50/12; H02J 7/00

(52) U.S. Cl. CPC H02J 50/60; H02J 7/00034; H02J 50/12; H04B 5/0037

(57) ABSTRACT

A method implemented by a processor of controlling a power receiver including a secondary-side resonant coil configured to receive power transmitted by magnetic field resonance or electric field resonance from a primary-side resonant coil of a power transmitter, the method includes: executing a motion detection processing that includes detecting a predetermined motion of a user; executing a mode control processing that includes starting a detection mode of detecting a beacon signal transmitted by the power transmitter when the predetermined motion is detected by the motion detection processing; and executing a response signal transmission processing that includes transmitting a response signal to the beacon signal when the beacon signal is detected in the detection mode.

### CROSS-REFERENCE TO RELATED APPLICATION

This application is a continuation application of International Application PCT/JP2017/034727 filed on Sep. 26, 2017 and designated the U.S., the entire contents of which are incorporated herein by reference.

### FIELD

The present invention relates to a power transmission system, a power receiver, and a method of controlling a power receiver.

### BACKGROUND

Conventionally, there is a wireless charger for being connected with a charging device via a wireless communication network, the wireless charger including a transmitter configured to transmit a power signal and a device scanner configured to scan one or a plurality of connection requests transmitted by the charging device.

The wireless charger further includes a receiver configured to receive the connection request via the wireless communication network from the charging device in response to the transmitted power signal, in which the transmitter is further configured to transmit a connection request of establishing connection with the charging device in response to the received connection request.

The wireless charger further includes a load detector configured to detect a load on the basis of the transmitted power signal, in which the device scanner is further configured to scan the one or the plurality of connection requests on the basis of the detected load.

An example of the related art includes Japanese National Publication of International Patent Application No. 2015-515851.

### SUMMARY

According to an aspect of the embodiments, a method implemented by a processor of controlling a power receiver including a secondary-side resonant coil configured to receive power transmitted by magnetic field resonance or electric field resonance from a primary-side resonant coil of a power transmitter, the method includes: executing a motion detection processing that includes detecting a predetermined motion of a user; executing a mode control processing that includes starting a detection mode of detecting a beacon signal transmitted by the power transmitter when the predetermined motion is detected by the motion detection processing; and executing a response signal transmission processing that includes transmitting a response signal to the beacon signal when the beacon signal is detected in the detection mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a power transmission system.

FIG. 2 is a diagram illustrating a power transmitter and a power receiver according to a first embodiment.

FIG. 3 is a diagram illustrating a configuration of a control unit according to the first embodiment.

FIG. 4 is a diagram illustrating the configuration of the control unit according to the first embodiment.

FIG. 5 is a flowchart illustrating processing executed by the control unit according to the first embodiment.

FIG. 6 is a flowchart illustrating the processing executed by the control unit according to the first embodiment.

FIG. 7 is a diagram illustrating an operation example of the power transmission system according to the first embodiment.

FIG. 8 is a diagram illustrating a power transmitter and a power receiver according to a second embodiment.

FIG. 9 is a diagram illustrating a configuration of a control unit according to the second embodiment.

FIG. 10 is a diagram illustrating the configuration of the control unit according to the second embodiment.

FIG. 11 is a flowchart illustrating processing executed by the control unit according to the second embodiment.

FIG. 12 is a flowchart illustrating the processing executed by the control unit according to the second embodiment.

FIG. 13 is a diagram illustrating an operation example of the power transmission system according to the second embodiment.

### DESCRIPTION OF EMBODIMENT(S)

By the way, a power transmission system like the conventional wireless charger detects presence or absence of a power receiver by a power transmitter detecting a change in load of the charging device.

Since the power transmitter detects the change in all loads around the power transmitter, the power transmitter may be difficult to detect the change in load of the charging device in a case where conductors and the like other than the power receiver are present. For example, when a detection threshold value of the change in load is increased in some degree in order to more easily detect the change in load of the charging device, it becomes difficult to detect the charging device weakly coupled with the power transmitter.

For this reason, the power transmission system like the conventional wireless charger may not be able to start charge of the charging device if the power transmission system cannot detect the charging device.

Therefore, an object is to provide a power transmission system, a power receiver, and a method of controlling a power receiver, which are capable of starting charge more reliably.

A power transmission system, a power receiver, and a method of controlling a power receiver, which are capable of starting charge more reliably, can be provided.

Exemplary embodiments of a power transmission system, a power receiver, and a method of controlling a power receiver will be described below.

### First Embodiment

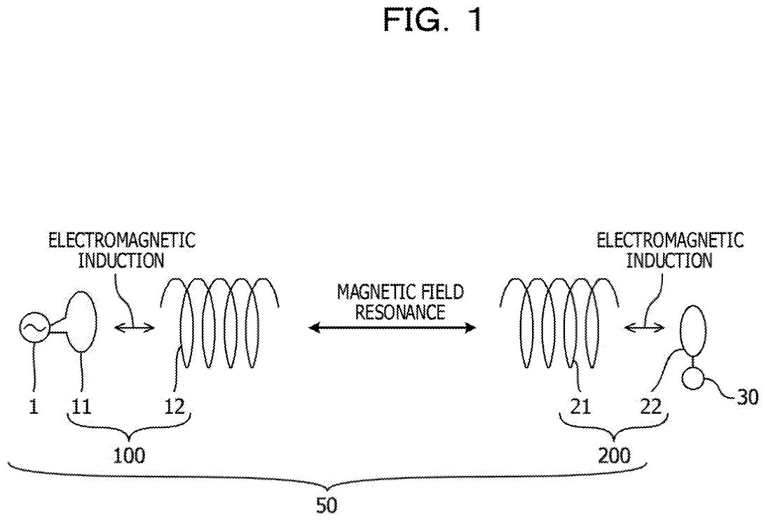

FIG. 1 is a diagram illustrating a power transmission system 50.

As illustrated in FIG. 1, the power transmission system 50 includes an alternating current (AC) power supply 1, a primary-side (power transmitting-side) power transmitter 100, and a secondary-side (power receiving-side) power receiver 200. The power transmission system 50 may include a plurality of power transmitters 100 and a plurality of power receivers 200.

The power transmitter 100 includes a primary-side coil 11 and a primary-side resonant coil 12. The power receiver 200 includes a secondary-side resonant coil 21 and a secondary-side coil 22. A load device 30 is connected to the secondary-side coil 22.

As illustrated in FIG. 1, the power transmitter 100 and the power receiver 200 perform energy (power) transmission from the power transmitter 100 to the power receiver 200 by magnetic field resonance (magnetic field resonance) between the primary-side resonant coil (LC resonator) 12 and the secondary-side resonant coil (LC resonator) 21. Here, the power transmission from the primary-side resonant coil 12 to the secondary-side resonant coil 21 can be performed not only by the magnetic field resonance but also by electric field resonance (electric field resonance) or the like. The following description will be given mainly using the magnetic field resonance as an example.

Furthermore, in the first embodiment, as an example, a case in which a frequency of an AC voltage to be output by the AC power supply 1 is 6.78 MHz, and a resonance frequency of each of the primary-side resonant coil 12 and the secondary-side resonant coil 21 is 6.78 MHz will be described. The AC power supply 1 is an example of a high-frequency power supply.

Note that the power transmission from the primary-side coil 11 to the primary-side resonant coil 12 is performed using electromagnetic induction. Furthermore, the power transmission from the secondary-side resonant coil 21 to the secondary-side coil 22 is also performed using electromagnetic induction.

Furthermore, FIG. 1 illustrates a mode in which the power transmission system 50 includes the primary-side coil 11. However, the power transmission system 50 does not necessarily include the primary-side coil 11. In this case, the AC power supply 1 is simply directly connected to the primary-side resonant coil 12. Likewise, FIG. 1 illustrates the mode in which the power transmission system 50 includes the secondary-side coil 22. However, the power transmission system 50 does not necessarily include the secondary-side coil 22. In this case, the load device 30 is simply directly connected to the secondary-side resonant coil 21.

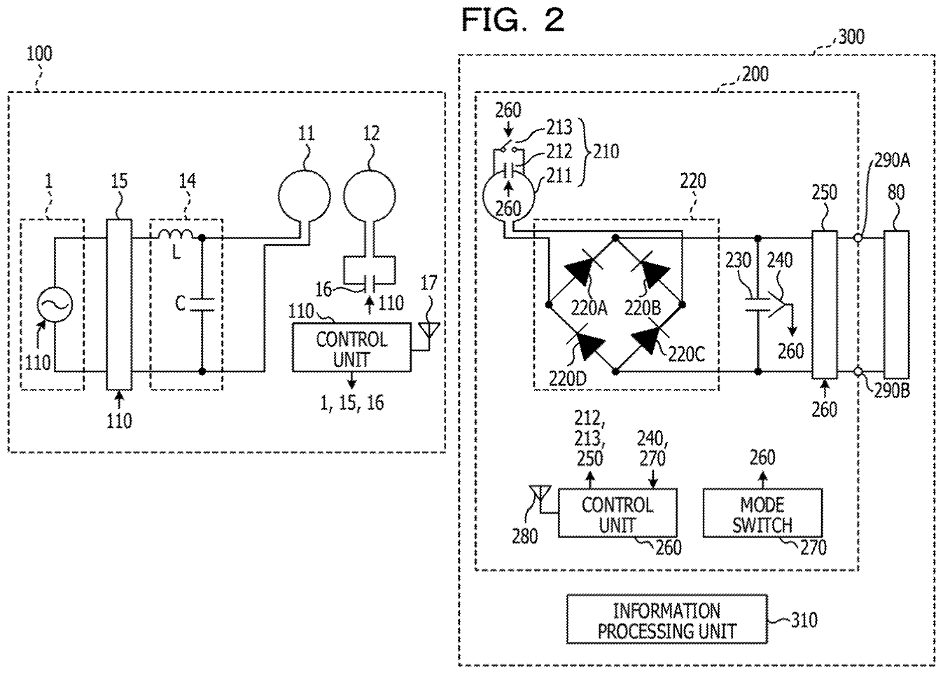

FIG. 2 is a diagram illustrating the power transmitter 100 and the power receiver 200 according to the first embodiment. In FIG. 2, the power receiver 200 is built in an electronic device 300. The electronic device 300 includes the power receiver 200, a battery 80, and an information processing unit 310, and is, for example, a tablet computer, a smartphone terminal, a smart watch, a game machine, or the like.

Here, constituent elements other than the power receiver 200, the battery 80, and the information processing unit 310 among constituent elements of the electronic device 300 are omitted, but the electronic device 300 may further include a display panel, a touch panel, a speaker, and the like. The information processing unit 310 is driven by power supplied from the battery 80.

The power transmitter 100 includes the AC power supply 1, the primary-side coil 11, the primary-side resonant coil 12, a matching circuit 14, a high-frequency amplifier 15, a capacitor 16, an antenna 17, and a control unit 110. Furthermore, the portion excluding the AC power supply 1 may be treated as the power transmitter 100. In this case, the AC power supply 1 and the power transmitter 100 may be treated in combination as a power transmission device.

The power receiver 200 includes a secondary-side resonant coil 210, a rectifier circuit 220, a smoothing capacitor 230, a voltage detection unit 240, a direct current (DC)-direct current (DC) converter 250, a control unit 260, a mode switch 270, an antenna 280, and output terminals 290A and 290B. The battery 80 is connected to the output terminals 290A and 290B. In FIG. 2, a load circuit is the battery 80. In FIG. 2, the secondary-side resonant coil 210 is directly connected to the rectifier circuit 220 without via the secondary-side coil 22 (see FIG. 1).

First, the power transmitter 100 will be described. As illustrated in FIG. 2, the primary-side coil 11 is a loop-shaped coil, and is connected at its two ends to the AC power supply 1 via the matching circuit 14 and the high-frequency amplifier 15. The primary-side coil 11 is disposed in close proximity to the primary-side resonant coil 12 in a noncontact manner, and is electromagnetically coupled to the primary-side resonant coil 12. The primary-side coil 11 is desirably disposed such that its central axis is aligned with the central axis of the primary-side resonant coil 12; however, the central axes are not necessarily aligned with each other. The central axes are aligned with each other for the purpose of improving coupling strength between the primary-side coil 11 and the primary-side resonant coil 12 and suppressing leakage of flux to suppress generation of an unnecessary electromagnetic field around the primary-side coil 11 and primary-side resonant coil 12.

The primary-side coil 11 generates a magnetic field by AC power supplied from the AC power supply 1 via the matching circuit 14 and the high-frequency amplifier 15, and transmits the power to the primary-side resonant coil 12 by electromagnetic induction (mutual induction).

As illustrated in FIG. 2, the primary-side resonant coil 12 is disposed in close proximity to the primary-side coil 11 in a noncontact manner, and is electromagnetically coupled to the primary-side coil 11. Furthermore, the primary-side resonant coil 12 is designed to have a predetermined resonance frequency and a high Q value. The resonance frequency of the primary-side resonant coil 12 is set to be equal to a resonance frequency of the secondary-side resonant coil 210. The capacitor 16 for adjusting the resonance frequency is connected in series between both ends of the primary-side resonant coil 12.

The resonance frequency of the primary-side resonant coil 12 is set to be the same frequency as a frequency of the AC power output by the AC power supply 1. The resonance frequency of the primary-side resonant coil 12 is determined according to an inductance of the primary-side resonant coil 12 and a capacitance of the capacitor 16. Therefore, the inductance of the primary-side resonant coil 12 and the capacitance of the capacitor 16 are set such that the resonance frequency of the primary-side resonant coil 12 becomes the same frequency as the frequency of the AC power output by the AC power supply 1.

The matching circuit 14 is inserted for impedance matching between the primary-side coil 11 and the AC power supply 1, and includes an inductor L and a capacitor C.

The AC power supply 1 is a power supply that outputs the AC power of a frequency necessary for the magnetic field resonance, and incorporates an amplifier that amplifies the output power. The AC power supply 1 outputs the AC power of a high frequency from about several tens of kHz to several tens of MHz, for example.

The high-frequency amplifier 15 amplifies the power (transmission power) input from the AC power supply 1 and outputs the amplified power to the matching circuit 14. An amplification factor of the high-frequency amplifier 15 is controlled by the control unit 110.

The capacitor 16 is a capacitor inserted in series between the both ends of the primary-side resonant coil 12. The capacitor 16 is provided for adjusting the resonance frequency of the primary-side resonant coil 12. The capacitor 16 may be a variable capacitance-type capacitor. In this case, the capacitance is set by the control unit 110.

The antenna 17 may be any antenna that can perform wireless communication at a short distance, such as Bluetooth (registered trademark), for example. The antenna 17 is connected to the control unit 110 and is used when performing data communication with the power receiver 200.

The control unit 110 performs control to cause the AC power supply 1 to output either one of transmission power for beacon signal and transmission power for charge. A mode for outputting the transmission power for beacon signal is a beacon signal output mode, and a mode for outputting the transmission power for charge is a charging power transmission mode.

The beacon signal is, for example, a pulsed signal using high-frequency power, which is built by alternately repeating a period in which high-frequency power that is the same as the transmission power for charge is output for a predetermined short period and a period in which the high-frequency power is not output for a predetermined period longer than the predetermined short period.

The high-frequency power output for the predetermined short period builds one pulse, and the one pulse includes high-frequency power of a plurality of cycles. A pulse width of the beacon signal is determined in advance. The beacon signal is an example of first transmission power. The transmission power for charge is continuous high-frequency power with a constant amplitude not having a pulse shape, and is an example of second transmission power.

Furthermore, the control unit 110 controls the transmission power by controlling the amplification factor of the high-frequency amplifier 15, and adjusts the capacitance of the capacitor 16 such that the resonance frequency of the primary-side resonant coil 12 becomes the same frequency as the frequency of the AC power output from the AC power supply 1. Since the resonance frequency is determined in advance, the capacitance of the capacitor 16 is a constant value that is also determined in advance.

The power transmitter 100 described above transmits the AC power, which is supplied from the AC power supply 1 to the primary-side coil 11, to the primary-side resonant coil 12 by magnetic induction, and transmits the power from the primary-side resonant coil 12 to the secondary-side resonant coil 210 of the power receiver 200 by magnetic field resonance. Note that FIG. 2 illustrates a mode in which one power transmitter 100 transmits the power to one power receiver 200. However, one power transmitter 100 can transmit the power to a plurality of power receivers 200.

Next, each constituent elements of the power receiver 200 will be described.

The secondary-side resonant coil 210 is designed to have the same resonance frequency as that of the primary-side resonant coil 12 and a high Q value. The secondary-side resonant coil 210 includes a coil unit 211, a capacitor 212, and a switch 213.

The coil unit 211 corresponds to the secondary-side resonant coil 21 illustrated in FIG. 1. The capacitor 212 is inserted in series in the coil unit 211.

The capacitor 212 is a variable capacitance-type capacitor connected in series to the coil unit 211 to adjust the resonance frequency. The capacitance of the capacitor 212 is adjusted by the control unit 260.

The resonance frequency of the secondary-side resonant coil 210 is determined according to an inductance of the coil unit 211 and a capacitance of the capacitor 212. Since the resonance frequency is determined in advance, the capacitance of the capacitor 212 is a constant value that is also determined in advance.

Furthermore, the switch 213 is connected in parallel to the capacitor 212, and is provided to realize a state where no resonance power flows through the coil unit 211. For this reason, the switch 213 can be treated as a resonance off switch.

The control unit 260 performs on/off control for the switch 213. A switch that is turned on (normally on) in a state where no instruction voltage is applied is desirable.

Since the current of high-frequency power does not flow through the capacitor 212 in the state where the switch 213 is on, no resonance occurs in the secondary-side resonant coil 210. The normally-on switch 213 is used to prevent the secondary-side resonant coil 210 from resonating in the state where the power receiver 200 is powered off.

For this reason, when receiving the transmission power for beacon signal or for charge, the control unit 260 applies an instruction voltage of the switch 213 to turn off the switch 213.

A pair of terminals of the coil unit 211 of the secondary-side resonant coil 210 is connected to the rectifier circuit 220. The secondary-side resonant coil 210 outputs, to the rectifier circuit 220, the AC power transmitted from the primary-side resonant coil 12 of the power transmitter 100 by magnetic field resonance.

The rectifier circuit 220 includes four diodes 220A to 220D. The diodes 220A to 2200 are connected in a bridge manner. The diodes 220A to 220D full-wave rectify and output the power input from the secondary-side resonant coil 210.

The smoothing capacitor 230 is connected to an output side of the rectifier circuit 220. The smoothing capacitor 230 smoothes the power full-wave rectified by the rectifier circuit 220, and outputs the smoothed power as DC power. The DC-DC converter 250 is connected to an output side of the smoothing capacitor 230. The power full-wave rectified by the rectifier circuit 220 can be treated as substantial AC power because a negative component of the AC power is inverted into a positive component. However, the use of the smoothing capacitor 230 enables stable DC power even in a case where the full-wave rectified power contains a ripple.

The voltage detection unit 240 detects a voltage between both ends of the smoothing capacitor 230 and outputs a signal representing a voltage value to the control unit 260. The voltage detection unit 240 is a voltage sensor.

The DC-DC converter 250 is a step-down DC-DC converter connected to the output side of the smoothing capacitor 230. The DC-DC converter 250 steps down the voltage of the DC power output from the smoothing capacitor 230 to a rated voltage for the battery 80, and outputs the rated voltage.

When the mode switch 270 is turned on by a user operation, the control unit 260 starts a detection mode for detecting a beacon signal, and detects the beacon signal in the detection mode. Furthermore, when detecting the beacon signal, the control unit 260 transmits a power transmission request signal in response to the beacon signal. The power transmission request signal is an example of a response signal. Furthermore, when preparation for the power transmission of the power transmitter 100 becomes ready after the control unit 260 transmits the power transmission request signal, the control unit 260 switches the mode from the detection mode to a charge mode. The charge mode is a mode to charge the battery 80 with the power received from the power transmitter 100.

When receiving charging power from the power transmitter 100 in the charge mode, the control unit 260 controls an output voltage of the DC-DC converter 250 on the basis of the voltage value input from the voltage detection unit 240.

The mode switch 270 is a switch operable by the user of the power receiver 200, and is provided on an outer surface of a casing of the electronic device 300. The mode switch 270 is a switch operated when the user who wants to charge the battery 80 starts the beacon signal detection mode. When the mode switch 270 is turned on, the power receiver 200 starts the detection mode. In other words, the detection mode is turned on when the mode switch 270 is turned on.

The antenna 280 may be any antenna that can perform wireless communication at a short distance, such as Bluetooth (registered trademark), for example. The antenna 280 is connected to the control unit 260 and is used when performing data communication with the power transmitter 100.

The output terminals 290A and 290B are terminals that convert the power received by the power receiver 200 into power having a predetermined voltage value and output the power. The battery 80 is connected to the output terminals 290A and 290B.

The battery 80 may be any rechargeable secondary battery, and a lithium-ion battery can be used, for example. The battery 80 is a main power source for supplying power to the electronic device 300.

Note that the primary-side coil 11, the primary-side resonant coil 12, and the secondary-side resonant coil 210 are prepared by winding a copper wire, for example. However, the material for the primary-side coil 11, the primary-side resonant coil 12, and the secondary-side resonant coil 210 may be any metal (e.g., gold, aluminum, and the like) other than copper. Furthermore, the materials for the primary-side coil 11, the primary-side resonant coil 12, and the secondary-side resonant coil 210 may be different from one another.

In such a configuration, the primary-side coil 11 and the primary-side resonant coil 12 are on the power transmission side, and the secondary-side resonant coil 210 is on the power reception side.

According to the magnetic field resonance method, power is transmitted from the power transmission side to the power reception side using the magnetic field resonance occurring between the primary-side resonant coil 12 and the secondary-side resonant coil 210. Therefore, longer-distance power transmission can be performed than the electromagnetic induction method of transmitting power from the power transmission side to the power reception side by electromagnetic induction.

With regard to distance or positional deviation between two resonant coils, the magnetic field resonance method is higher in degree of freedom than the electromagnetic induction method, and has a merit of being free of position.

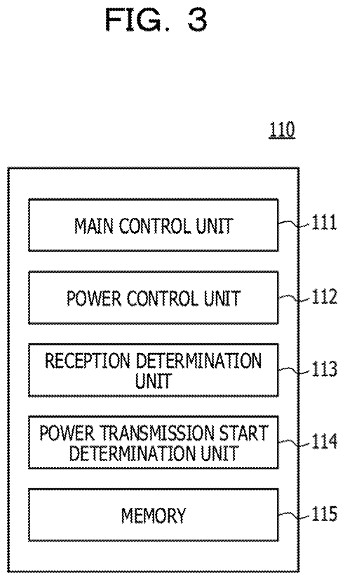

FIG. 3 is a diagram illustrating a configuration of the control unit 110 according to the first embodiment. The control unit 110 includes a main control unit 111, a power control unit 112, a reception determination unit 113, a power transmission start determination unit 114, and a memory 115.

The control unit 110 is embodied by, for example, a central processing unit (CPU) chip including a CPU and a memory. The memory of the CPU chip includes at least a nonvolatile memory. The main control unit 111, the power control unit 112, the reception determination unit 113, and the power transmission start determination unit 114 represent, as blocks, functions obtained by the control unit 110 as a CPU chip executing a program. The memory 115 represents the memory of the CPU chip as a block.

The main control unit 111 is a processing unit that generally controls the control by the control unit 110, and executes processing other than processing executed by the power control unit 112, the reception determination unit 113, and the power transmission start determination unit 114. Furthermore, the main control unit 111 performs data communication with the power receiver 200 via the antenna 17 (see FIG. 2).

The power control unit 112 executes control processing of causing the AC power supply 1 to output either one of the transmission power for beacon signal or the transmission power for charge, processing of controlling the transmission power by controlling the amplification factor of the high-frequency amplifier 15, processing of adjusting the capacitance of the capacitor 16, and the like.

The control processing of outputting the beacon signal is processing of searching for the power receiver 200 in the beacon signal output mode. In the beacon signal output mode, the power control unit 112 causes the AC power supply 1 to repeatedly output transmission power of a pulsed resonance frequency (6.78 MHz) for a predetermined short period as the beacon signal.

The control processing of outputting the transmission power for charge is processing of outputting optimum transmission power for charge for charging the battery 80 connected to the power receiver 200 in the charging power transmission mode.

The reception determination unit 113 determines whether or not having received the power transmission request signal from the power receiver 200. In the case where there is a plurality of power receivers 200, the reception determination unit 113 determines whether or not having received the power transmission request signal from at least one of the plurality of power receivers 200.

In a case where the reception determination unit 113 determines having received the power transmission request signal, the power transmission start determination unit 114 transmits a power transmission start notification to the power receiver 200 and causes the power control unit 112 to set the transmission power for charge as the transmission power. As a result, the power control unit 112 performs control processing for causing the AC power supply 1 to output the transmission power for charge. The power transmission start notification is a notification signal that notifies the power receiver 200 that transmission of the transmission power for charge is started.

The memory 115 stores programs, data, and the like necessary for the control unit 110 to execute the above-described various types of processing.

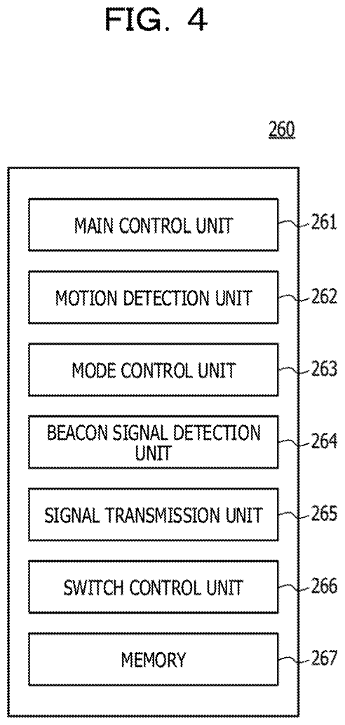

FIG. 4 is a diagram illustrating a configuration of the control unit 260 according to the first embodiment.

The control unit 260 includes a main control unit 261, a motion detection unit 262, a mode control unit 263, a beacon signal detection unit 264, a signal transmission unit 265, a switch control unit 266, and a memory 267.

As an example, the control unit 260 is implemented by a CPU chip including a CPU and a memory. The memory of the CPU chip includes at least a nonvolatile memory. The main control unit 261, the motion detection unit 262, the mode control unit 263, the beacon signal detection unit 264, the signal transmission unit 265, and the switch control unit 266 represent, as blocks, functions obtained by the control unit 260 as a CPU chip executing a program. The memory 267 represents the memory of the CPU chip as a block.

The main control unit 261 is a processing unit that generally controls the control by the control unit 260, and executes processing other than processing executed by the motion detection unit 262, the mode control unit 263, the beacon signal detection unit 264, the signal transmission unit 265, and the switch control unit 266. Furthermore, the main control unit 261 performs data communication with the power transmitter 100 via the antenna 280 (see FIG. 2).

Furthermore, the main control unit 261 monitors a charge state of the battery 80 and determines whether or not charge has been completed. The monitoring the charge state is performed by detecting a state of charge (SOC) of the battery 80.

The motion detection unit 262 detects that the mode switch 270 has been turned on. The user performing an operation to turn on the mode switch 270 is an example of a predetermined motion of the user turning on the detection mode of detecting a beacon signal.

The mode control unit 263 performs control processing of setting the mode of the power receiver 200 to any of the detection mode of detecting the beacon signal, the charge mode of receiving the transmission power for charge, and a standby mode. Note that the standby mode is neither the detection mode nor the charge mode, and is a mode for standing by.

When on of the mode switch 270 is detected by the motion detection unit 262, the mode control unit 263 changes the mode to start the detection mode of detecting the beacon signal.

Furthermore, the mode control unit 263 includes a timer that counts a predetermined time T2 after the detection mode is started. In a case where the beacon signal is not detected by the beacon signal detection unit 264 within the predetermined time T2 after the detection mode is started, the mode control unit 263 terminates the detection mode and sets the standby mode. The predetermined time T2 is an example of a second predetermined time.

Furthermore, when receiving the power transmission start notification from the power transmitter 100, the mode control unit 263 changes the mode to start the charge mode.

When the mode of the power receiver 200 is set to the detection mode by the mode control unit 263, the beacon signal detection unit 264 monitors the voltage value detected by the voltage detection unit 240 and detects the beacon signal. Since the pulse width and pulse interval of the beacon signal are predetermined and stored in the memory 267, the beacon signal detection unit 264 reads the pulse width and pulse interval of the beacon signal stored in the memory 267, and detects the beacon signal by comparing the read pulse width and pulse interval with the voltage value detected by the voltage detection unit 240.

When the beacon signal is detected by the beacon signal detection unit 264, the signal transmission unit 265 transmits the power transmission request signal. The signal transmission unit 265 is an example of a response signal transmission unit, and the power transmission request signal is an example of a response signal with which the power receiver 200 that has received the beacon signal responds to the beacon signal.

When on of the mode switch 270 is detected by the motion detection unit 262, the switch control unit 266 turns off the switch 213 to set a state where resonance power flows through the coil unit 211.

Furthermore, the switch control unit 266 includes a time that counts an elapsed time from when the power transmission request signal has been transmitted from the signal transmission unit 265 to the power transmitter 100. In a case where the charging power is not detected by the voltage detection unit 240 within a predetermined time T3 from when the power transmission request signal has been transmitted from the signal transmission unit 265 to the power transmitter 100, the switch control unit 266 turns on the switch 213 to set the state where no resonance power flows through the coil unit 211. The predetermined time T3 is an example of a third predetermined time. The voltage detection unit 240 detects the voltage value of the charging power.

The memory 267 stores programs, data, and the like necessary for the control unit 260 to execute the above-described various types of processing. As a specific example, the memory 267 stores data indicating the pulse width and pulse interval of the beacon signal.

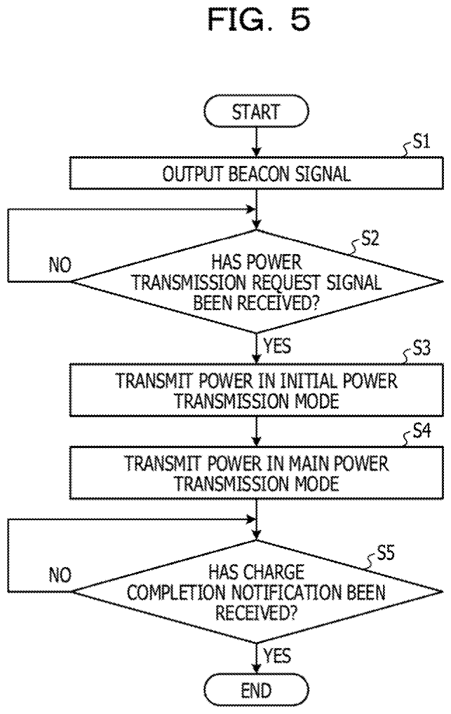

FIG. 5 is a flowchart illustrating processing executed by the control unit 110 according to the first embodiment.

The main control unit 111 starts processing when the power transmitter 100 is powered on.

Next, the power control unit 112 performs the control processing for causing the AC power supply 1 to output the beacon signal (step S1). Thereby, AC power supply 1 outputs the beacon signal.

Next, the reception determination unit 113 determines whether or not having received the power transmission request signal from the power receiver 200 (step S2). In the case where there is a plurality of power receivers 200, the reception determination unit 113 determines having received the power transmission request signal when having received the power transmission request signal from at least one of the plurality of power receivers 200. Note that, in a case where the reception determination unit 113 determines not having received the power transmission request signal (S2: NO), the reception determination unit 113 repeatedly executes the processing in step S2 until determining reception of the power transmission request signal.

When the reception determination unit 113 determines having received the power transmission request signal (S2: YES), the power control unit 112 executes power transmission by an initial power transmission mode (step S3). The initial power transmission mode is a mode of transmitting power for initial power transmission. The power for initial power transmission is set to a relatively large power to bring the power receiver 200 into the charge state at an early stage. Note that the time for transmitting power in the initial power transmission mode is determined in advance.

Next, the power control unit 112 executes power transmission in a main power transmission mode (step S4). The main power transmission mode is a mode in which the power transmitter 100 performs data communication with the power receiver 200, and transmits the optimal transmission power on the basis of a rated output, a charge amount, and the like of the battery 80 connected to the power receiver 200.

Next, the main control unit 111 determines whether or not having received a charge completion notification from the power receiver 200 (step S5). The charge completion notification is a notification indicating that the charge of the battery 80 has been completed, and is transmitted from the power receiver 200 to the power transmitter 100 when the charge has been completed. Note that the main control unit 111 repeatedly executes the processing in step S5 until receiving the charge completion notification.

When receiving the charge completion notification, the main control unit 111 terminates the series of processing (end). Note that the main control unit 111 returns the flow to step S1 when the processing in step S5 ends, and repeatedly executes the processing from step S1 to S5 until the power transmitter 100 is powered off.

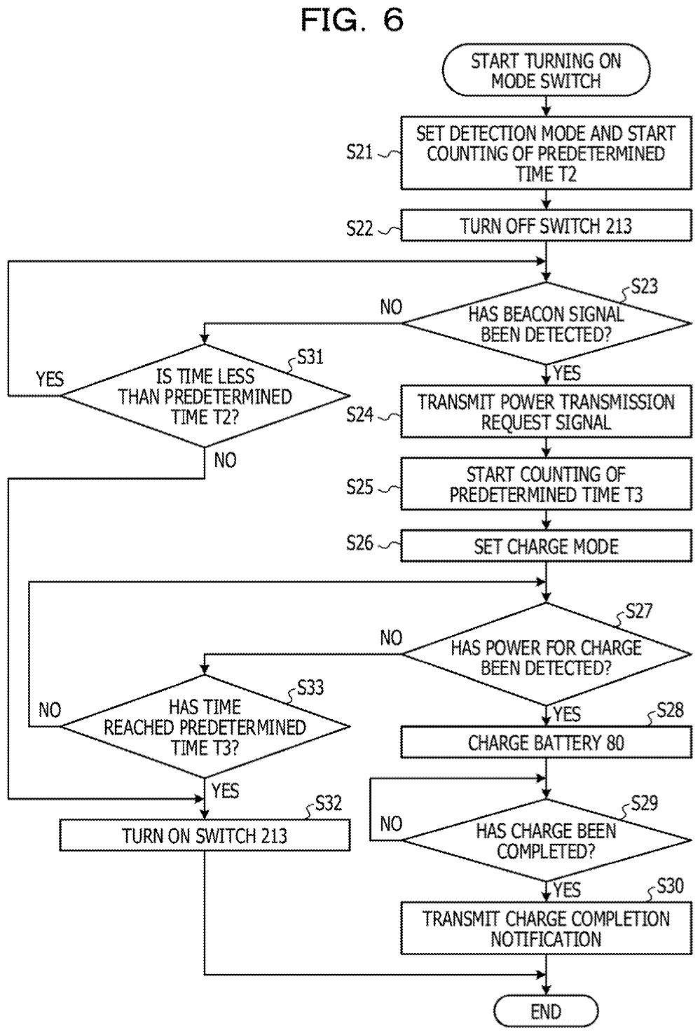

FIG. 6 is a flowchart illustrating processing executed by the control unit 260 according to the first embodiment.

When the motion detection unit 262 detects that the mode switch 270 has been turned on, the main control unit 261 starts the processing.

First, the mode control unit 263 sets the mode of the power receiver 200 to the detection mode, and starts counting of the predetermined time T2 with the timer (step S21).

Next, the switch control unit 266 turns off the switch 213 to set the state where resonance power flows through the coil unit 211 (step S22).

Next, the beacon signal detection unit 264 monitors the voltage value detected by the voltage detection unit 240 and determines whether or not having detected the beacon signal (step S23).

When the beacon signal detection unit 264 determines having detected the beacon signal (S23: YES), the signal transmission unit 265 transmits the power transmission request signal (step S24).

Next, the switch control unit 266 starts counting of a predetermined time T3 with the timer in order to measure an elapsed time from when the power transmission request signal has been transmitted from the signal transmission unit 265 to the power transmitter 100 (step S25).

Next, the mode control unit 263 sets the mode of the power receiver 200 to the charge mode of receiving the transmission power for charge (step S26).

Next, the main control unit 261 determines whether or not the power for charge has been detected (step S27). The determination as to whether or not the power for charge has been detected is performed by determining whether or not the voltage value detected by the voltage detection unit 240 is a continuous voltage value and is a voltage value for charge.

When determining that the power for charge has been detected (S27: YES), the main control unit 261 controls the DC-DC converter 250 and the like to charge the battery 80 (step S28).

Next, the main control unit 261 monitors the charge state of the battery 80 and determines whether or not the charge has been completed (step S29). The main control unit 261 repeatedly executes the processing in step S29 until the charge of the battery 80 is completed.

When determining that the charge of the battery 80 has been completed (S29: YES), the main control unit 261 transmits the charge completion notification indicating completion of charge to the power transmitter 100 (step S30).

When transmitting the charge completion notification to the power transmitter 100, the main control unit 261 terminates the series of processing (end).

Furthermore, when the beacon signal detection unit 264 determines having not detected the beacon signal (S23: NO) in step S23, the mode control unit 263 determines whether or not the elapsed time counted with the timer is less than the predetermined time T2 (step S31). Since there is a possibility that the user stops charging for some reason and the like in a case where a beacon signal undetected state continues for a long time, the processing stands by for the predetermined time T2.

When the mode control unit 263 determines that the elapsed time is less than the predetermined time T2 (S31: YES) in step S31, the main control unit 261 returns the flow to step S23. This is for determining whether or not the beacon signal has been detected again because the predetermined time T2 has not elapsed.

Furthermore, when the mode control unit 263 determines that the elapsed time is not less than the predetermined time T2 (S31: NO) in step S31, the switch control unit 266 turns on the switch 213 (step S32). As a result, the state is switched to the state where no resonance power flows through the coil unit 211. In a case where the predetermined time T2 has elapsed without detecting the beacon signal, an unreceived state of power has occurred for some reason. Therefore, the state is switched to the state where no resonance power flows through the coil unit 211.

Furthermore, when the main control unit 261 determines that the power for charge has not been detected (S27: NO) in step S27, the switch control unit 266 determines whether or not a count time of the timer has reached the predetermined time T3 (step S33). Since there is a possibility of occurrence of an unchargeable state like a case where the power receiver 200 is separated from the power transmitter 100 in a case where an undetected state of the power for charge continues for a long time, the time limit of the predetermined time T3 is provided. Note that the count time of the timer reaching the predetermined time T3 means that the count time of the time becomes equal to the predetermined time T3.

When the switch control unit 266 determines that the count time has not reached the predetermined time T3 (S33: NO), the main control unit 261 returns the flow to step S27.

Furthermore, when the switch control unit 266 determines that the count time has reached the predetermined time T3 (S33: YES), the switch control unit 266 turns on the switch 213 (step S32). As a result, the state is switched to the state where no resonance power flows through the coil unit 211. In a case where the predetermined time T3 has elapsed without receiving the power for charge since the transmission of the power transmission request signal, an unreceived state of power has occurred for some reason. Therefore, the state is switched to the state where no resonance power flows through the coil unit 211. The series of processing is performed as described above.

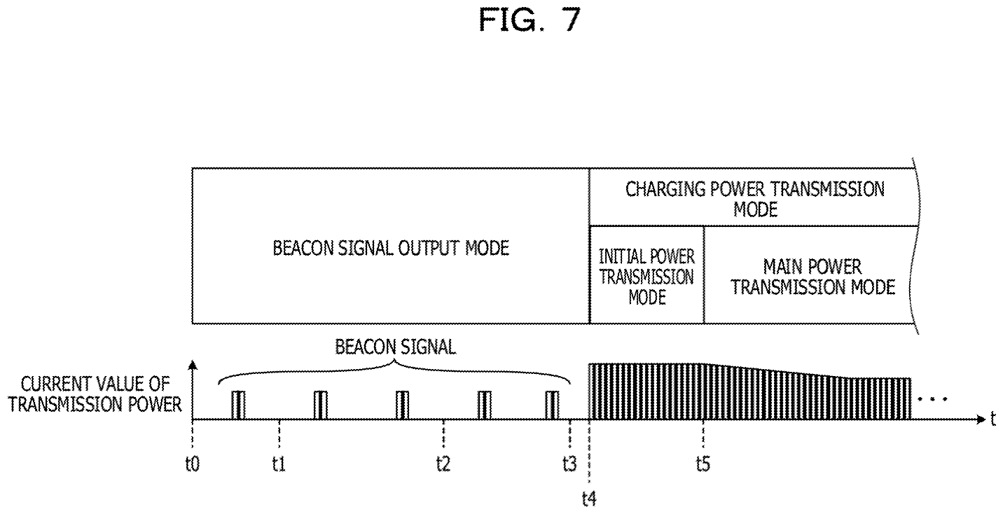

FIG. 7 is a diagram illustrating an operation example of the power transmission system 50 according to the first embodiment FIG. 7 illustrates the modes of the power transmitter 100, temporal change in the transmission power, and operation timing of the power receiver 200. Note that the horizontal axis is a time axis.

At time t0, the power transmitter 100 outputs the beacon signal in the beacon signal output mode. Here, at time t1, the mode switch 270 of the power receiver 200 is turned on, and the power receiver 200 is present in a beacon signal detectable range for the power transmitter 100.

At time t2, the power receiver 200 detects the beacon signal. At time t3, the power receiver 200 transmits the power transmission request signal to the power transmitter 100.

Then, at time t4, the power transmitter 100 is switched to the initial power transmission mode of the charging power transmission mode, and transmits the power for initial power transmission. The power for initial power transmission is set to a relatively large power to bring the power receiver 200 into the charge state at an early stage.

Furthermore, at time t5, the power transmitter 100 is switched from the initial power transmission mode to the main power transmission mode of the charging power transmission mode. In the main power transmission mode, for example, the power transmitter 100 performs data communication with the power receiver 200 and is set to the optimal transmission power on the basis of the rated output, the charge amount, and the like of the battery 80 connected to the power receiver 200.

When the mode switch 270 of the power receiver 200 is turned on, and the power receiver 200 detects the beacon signal, as described above, the power receiver 200 transmits the power transmission request signal to the power transmitter 100. In response to the power transmission request signal, the power transmitter 100 transmits the power for charge to the power receiver 200.

As described above, according to the first embodiment, the power receiver 200 includes the mode switch 270, and when the mode switch 270 is turned on by the user, the power receiver 200 is set to be in the detection mode of detecting the beacon signal. Then, when detecting the beacon signal in the detection mode, the power receiver 200 transmits the power transmission request signal to the power transmitter 100. That is, the power receiver 200 detecting the beacon signal is a trigger for starting charge.

Here, the power receiver 200 can detect the beacon signal having a predetermined signal strength regardless of the presence or absence of conductors in the surroundings, or the like. The detection of the beacon signal in the power receiver 200 is much more reliable than detection of a charging device by a power transmitter in a conventional power transmission system. This is because the power receiver 200 can detect a minute change in the signal level of the beacon signal, as compared with a change in the load viewed from the power transmitter of the conventional power transmission system.

Then, the power receiver 200 that has detected the beacon signal in the detection mode transmits the power transmission request signal to the power transmitter 100, and the power for charge is transmitted from the power transmitter 100 that has received the power transmission request signal. Therefore, according to the first embodiment, charge of the power receiver 200 can be more reliably started.

Therefore, the power transmission system 50, the power receiver 200, and the method of controlling the power receiver 200, which are capable of starting charge more reliably, can be provided.

Note that, in the above description, a mode in which the power receiver 200 includes the mode switch 270 and the user performs the motion to operate the mode switch 270 has been described as an example of the predetermined motion to turn on the detection mode of detecting the beacon signal by the user. However, the predetermined motion to turn on the detection mode may be a motion other than such a motion.

### Second Embodiment

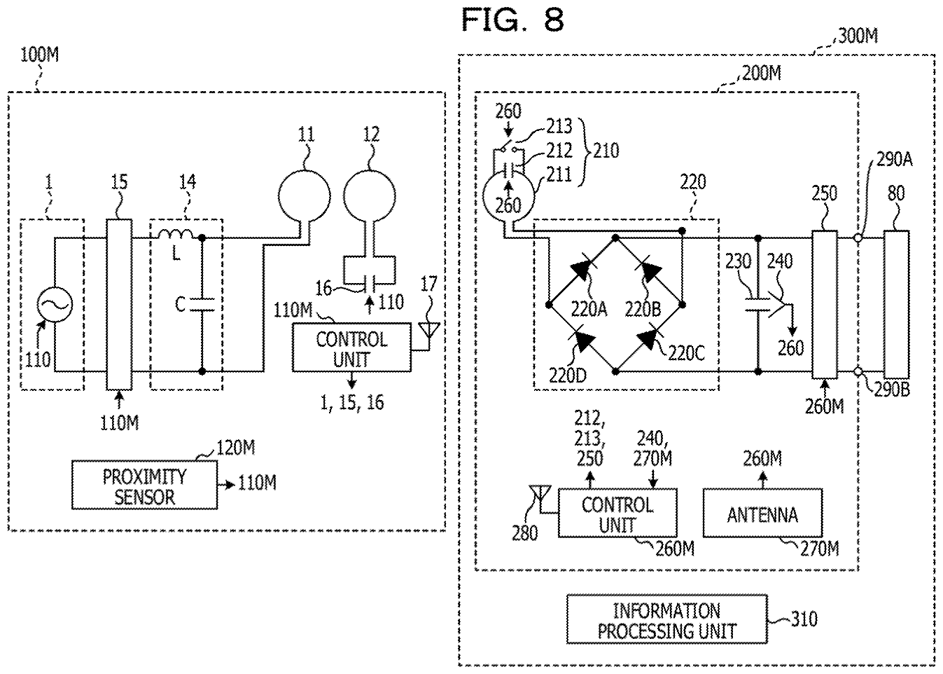

FIG. 8 is a diagram illustrating a power transmitter 100M and a power receiver 200M according to a second embodiment. In FIG. 8, the power receiver 200M is built in an electronic device 300M. Hereinafter, constituent elements similar to those in the first embodiment are denoted by the same reference numerals and description thereof will be omitted. Furthermore, description will be given focusing on differences from the power transmitter 100, the power receiver 200, and the electronic device 300 according to the first embodiment.

The electronic device 300M includes the power receiver 200M, a battery 80, and an information processing unit 310, and is, for example, a tablet computer and the like, similarly to the electronic device 300 according to the first embodiment.

The power transmitter 100M includes a proximity sensor 120M in addition to an AC power supply 1, a primary-side coil 11, a primary-side resonant coil 12, a matching circuit 14, a high-frequency amplifier 15, a capacitor 16, an antenna 17, and a control unit 110M. In other words, the power transmitter 100M has a configuration in which the control unit 110 of the power transmitter 100 of the first embodiment is replaced with the control unit 110M, and the proximity sensor 120M is added. Note that the portion excluding the AC power supply 1 may be treated as the power transmitter 100M. In this case, the AC power supply 1 and the power transmitter 100M may be treated in combination as a power transmission device.

The power receiver 200M includes a secondary-side resonant coil 210, a rectifier circuit 220, a smoothing capacitor 230, a voltage detection unit 240, a DC-DC converter 250, a control unit 260M, an antenna 270M, an antenna 280, and output terminals 290A and 290B. In other words, the power receiver 200M has a configuration in which the control unit 260 and the mode switch 270 of the power receiver 200 of the first embodiment are replaced with the control unit 260M and the antenna 270M.

The control unit 110M operates in a read mode of reading the power receiver 200M with the proximity sensor 120M when the power transmitter 100M is powered on, in addition to operating in a beacon signal output mode and a charging power transmission mode, similarly to the control unit 110 of the first embodiment. When the power receiver 200M is detected by the proximity sensor 120M in the read mode, the control unit 110M transitions to the beacon signal output mode.

The proximity sensor 120M is a device (reader device) that reads a proximity communication device that performs non-contact proximity communication such as FeliCa (registered trademark), for example, and is an example of a communication detection unit that detects proximity communication.

As an example, the proximity sensor 120M has a communication range within a radius of 1 meter centered on the proximity sensor 120M, and detects the presence of a proximity communication device within the communication range. Here, the proximity communication device is the power receiver 200M or the electronic device 300M including the antenna 270M. The proximity sensor 120M radiates radio waves for proximity communication within the communication range.

When the antenna 270M included in the power receiver 200M or the electronic device 300M is held over the proximity sensor 120M, the control unit 260M connected to the antenna 270M performs proximity communication with the power of the radio waves received via the antenna 270M and responds to the proximity sensor 120M. Therefore, the proximity sensor 120M can detect that the antenna 270M has entered the communication range. In other words, the proximity sensor 120M can read the power receiver 200M having the antenna 270M.

Note that the response of the control unit 260M is to transmit a signal indicating that the power receiver 200M or the electronic device 300M including the antenna 270M is present within the communication range, and may include data indicating an identifier of the antenna 270M, the power receiver 200M, or the electronic device 300M.

Next, each constituent element of the power receiver 200M will be described.

When the power receiver 200M is read by the proximity sensor 120M, the control unit 260M starts the detection mode of detecting a beacon signal, and detects the beacon signal in the detection mode. Furthermore, when detecting the beacon signal, the control unit 260M transmits a power transmission request signal in response to the beacon signal. In other words, the operation of the control unit 260 of the first embodiment is triggered when the mode switch 270 is turned on, whereas the operation of the control unit 260M is triggered when the power receiver 200M is read by the proximity sensor 120M. Other operations are similar to those of the control unit 260 of the first embodiment.

The antenna 270M is provided near an outer surface of a casing of the electronic device 300M. The antenna 270M is a proximity communication device used when a user who wants to charge the battery 80 starts the detection mode of the beacon signal, and is an example of a proximity communication unit. When the power receiver 200M is read by the proximity sensor 120M, the power receiver 200M starts the detection mode.

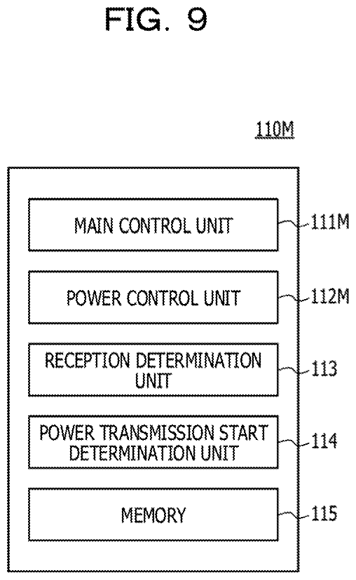

FIG. 9 is a diagram illustrating a configuration of the control unit 110M according to the second embodiment. The control unit 110M includes a main control unit 111M, a power control unit 112M, a reception determination unit 113, a power transmission start determination unit 114, and a memory 115.

The main control unit 111M is a processing unit that generally controls the control by the control unit 110M, and executes processing other than processing executed by the power control unit 112M, the reception determination unit 113, and the power transmission start determination unit 114. Furthermore, the main control unit 111M performs data communication with the power receiver 200M via the antenna 17 (see FIG. 8).

The power control unit 112M includes a timer that counts an elapsed time from when the proximity sensor 120M has started the proximity communication detection processing, and performs processing of counting a predetermined time T1. The predetermined time T1 is an example of a first predetermined time.

Furthermore, the power control unit 112M performs processing of stopping transmission of transmission power for charge in a predetermined case. Furthermore, the power control unit 112M performs similar processing to the processing of the power control unit 112 of the first embodiment, in addition to the above processing.

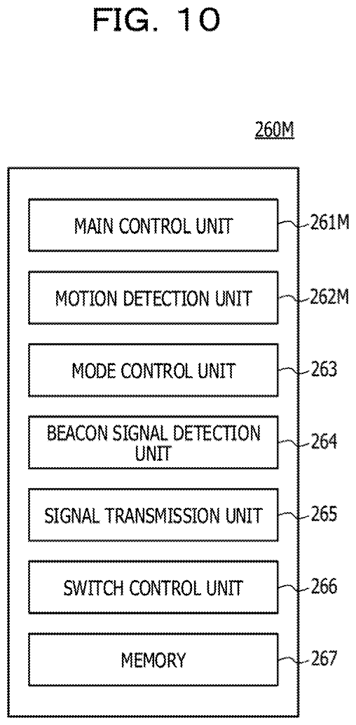

FIG. 10 is a diagram illustrating a configuration of the control unit 260M according to the second embodiment.

The control unit 260M includes a main control unit 261M, a motion detection unit 262M, a mode control unit 263, a beacon signal detection unit 264, a signal transmission unit 265, a switch control unit 266, and a memory 267.

The main control unit 261M is a processing unit that generally controls the control by the control unit 260M, and executes processing other than processing executed by the motion detection unit 262M, the mode control unit 263, the beacon signal detection unit 264, the signal transmission unit 265, and the switch control unit 266. Furthermore, the main control unit 261M performs similar processing to the processing of the main control unit 261 of the first embodiment, except for the processing changed due to the power receiver 200M including the antenna 270M.

When the antenna 270M enters the communication range of the proximity sensor 120M, and the motion detection unit 262M receives radio waves from the proximity sensor 120M, the motion detection unit 262M detects that the power receiver 200M has been read by the proximity sensor 120M. The user bringing the antenna 270M of the power receiver 200M close to the proximity sensor 120M to cause the proximity sensor 120M to read the power receiver 200M is an example of a predetermined motion of the user turning on the detection mode of detecting a beacon signal.

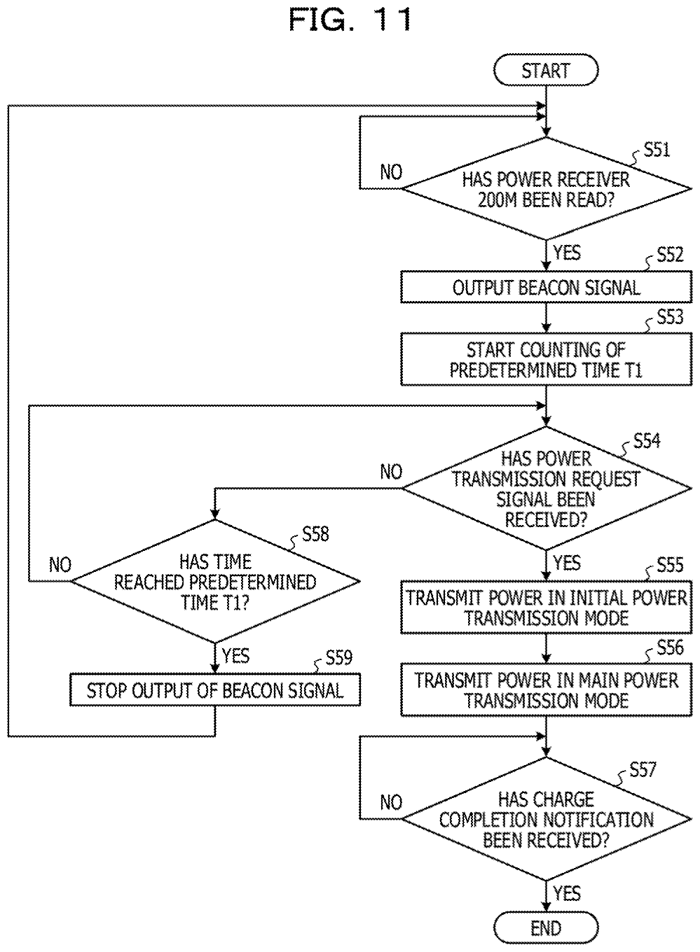

FIG. 11 is a flowchart illustrating processing executed by the control unit 110M according to the second embodiment.

The main control unit 111M starts processing when the power transmitter 100M is powered on.

Next, the main control unit 111M determines whether or not the power receiver 200M including the antenna 270M has been read by the proximity sensor 120M (step S51). When determining that the power receiver 200M has not been read (S51: NO), the main control unit 111M repeatedly executes the processing in step S51 until the power receiver 200M is read.

When the main control unit 111M determines that the power receiver 200M has been read (S51: YES), the power control unit 112M performs control processing of causing the AC power supply 1 to output the beacon signal (step S52). As a result, the power transmitter 100M enters the beacon signal output mode, and the AC power supply 1 outputs the beacon signal.

Next, the power control unit 112M starts counting of the predetermined time T1 with the timer in order to measure the elapsed time from when the proximity sensor 120M has started the proximity communication detection processing (step S53).

Next, the reception determination unit 113 determines whether or not having received the power transmission request signal from the power receiver 200M (step S54). In the case where there is a plurality of power receivers 200M, the reception determination unit 113 determines having received the power transmission request signal when having received the power transmission request signal from at least one of the plurality of power receivers 200M.

When the reception determination unit 113 determines having received the power transmission request signal (S54: YES), the power control unit 112M executes power transmission by an initial power transmission mode (step S55).

Next, the power control unit 112M executes power transmission in a main power transmission mode (step S56).

Next, the main control unit 111M determines whether or not having received a charge completion notification from the power receiver 200M (step S57). The charge completion notification is a notification indicating that the charge of the battery 80 has been completed, and is transmitted from the power receiver 200M to the power transmitter 100M when the charge has been completed. Note that the main control unit 111M repeatedly executes the processing in step S57 until receiving the charge completion notification.

When receiving the charge completion notification, the main control unit 111M terminates the series of processing (end). Note that the main control unit 111M returns the flow to step S51 when the processing in step S57 ends, and repeatedly executes the processing from step S51 until the power transmitter 100M is powered off.

Furthermore, in a case of determining in step S54 that the reception determination unit 113 has not received the power transmission request signal (S54: NO), the power control unit 112M determines whether or not an elapsed time counted by the timer has reached the predetermined time T1 (step S58).

When the power control unit 112M determines that the elapsed time has not reached the predetermined time T1 (S58: NO), the main control unit 111M returns the flow to step S54. This is for determining whether or not the power transmission request signal has been received from the power receiver 200M until the elapsed time reaches the predetermined time T1.

When the power control unit 112M determines that the elapsed time has reached the predetermined time T1 (S58: YES), the power control unit 112M causes the AC power supply 1 to stop the output of the beacon signal (step S59). As a result, the power receiver 200 enters the standby mode.

When the processing in step S59 ends, the main control unit 111M returns the flow to step S51. This is for determining whether or not the power receiver 200M including the antenna 270M has been read by the proximity sensor 120M in step S51 because there is still a possibility that the user holds the antenna 270M over the proximity sensor 120M.

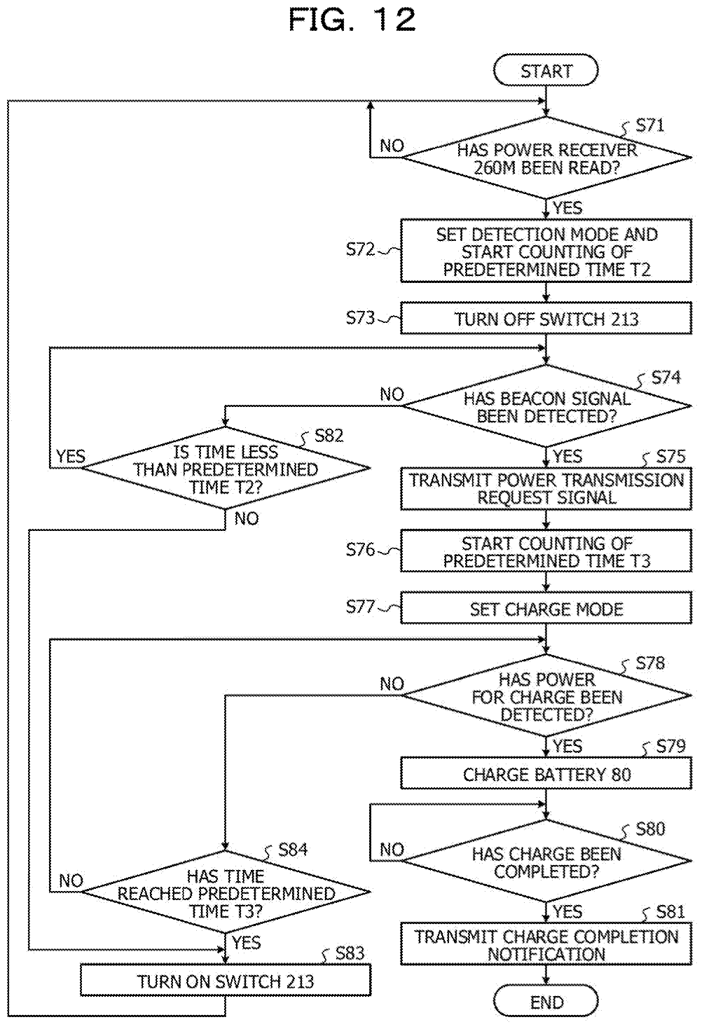

FIG. 12 is a flowchart illustrating processing executed by the control unit 260M according to the second embodiment.

The main control unit 261M starts the processing when the power receiver 200 is powered on.

First, the motion detection unit 262M determines whether or not the power receiver 200M has been read by the proximity sensor 120M (step S71). When determining that the power receiver 200M has not been read by the proximity sensor 120M (S71: NO), the motion detection unit 262M repeatedly executes the processing in step S71 until the power receiver 200M is read by the proximity sensor 120M.

When the motion detection unit 262M determines that the power receiver 200M has been read by the proximity sensor 120M (S71: YES), the mode control unit 263 sets the mode of the power receiver 200M to the detection mode, and starts counting of a predetermined time T2 with the timer (step S72).

Next, the switch control unit 266 turns off the switch 213 to set a state where resonance power flows through the coil unit 211 (step S73).

Next, the beacon signal detection unit 264 monitors the voltage value detected by the voltage detection unit 240 and determines whether or not having detected the beacon signal (step S74).

When the beacon signal detection unit 264 determines having received the beacon signal (S74: YES), the signal transmission unit 265 transmits the power transmission request signal (step S75).

Next, the switch control unit 266 starts counting of a predetermined time T3 with the timer in order to measure the elapsed time from when the power transmission request signal has been transmitted from the signal transmission unit 265 to the power transmitter 100M (step S76).

Next, the mode control unit 263 sets the mode of the power receiver 200M to the charge mode of receiving the transmission power for charge (step S77).

Next, the main control unit 261M determines whether or not the power for charge has been detected (step S78). The determination as to whether or not the power for charge has been detected is performed by determining whether or not the voltage value detected by the voltage detection unit 240 is a continuous voltage value and is a voltage value for charge.

When determining that the power for charge has been detected (S78: YES), the main control unit 261M controls the DC-DC converter 250 and the like to charge the battery 80 (step S79).

Next, the main control unit 261M monitors the charge state of the battery 80 and determines whether or not the charge has been completed (step S80). The main control unit 261M repeatedly executes the processing in step S80 until the charge of the battery 80 is completed.

When determining that the charge of the battery 80 has been completed (S80: YES), the main control unit 261M transmits the charge completion notification indicating completion of charge to the power transmitter 100M (step S81).

When transmitting the charge completion notification to the power transmitter 100M, the main control unit 261M terminates the series of processing (end).

Furthermore, when the beacon signal detection unit 264 determines having not detected the beacon signal (S74: NO) in step S74, the mode control unit 263 determines whether or not the elapsed time counted with the timer is less than the predetermined time T2 (step S82). Since there is a possibility that the user stops charging for some reason and the like in a case where a beacon signal undetected state continues for a long time, the processing stands by for the predetermined time T2.

When the mode control unit 263 determines in step S82 that the elapsed time is less than the predetermined time T2 (S82: YES), the main control unit 261M returns the flow to step S74. This is for determining whether or not the beacon signal has been detected again because the predetermined time T2 has not elapsed.

Furthermore, when the mode control unit 263 determines in step S82 that the elapsed time is not less than the predetermined time T2 (S82: NO), the switch control unit 266 turns on the switch 213 (step S83). As a result, the state is switched to a state where no resonance power flows through the coil unit 211. In a case where the predetermined time T2 has elapsed without detecting the beacon signal, an unreceived state of power has occurred for some reason. Therefore, the state is switched to the state where no resonance power flows through the coil unit 211.

When the processing in step S83 ends, the main control unit 261M returns the flow to step S71. This is for preparing for the motion by the user to bring the power receiver 200 close to the proximity sensor 120M again

Furthermore, when the main control unit 261M determines that the power for charge has not been detected (S78: NO) in step S78, the switch control unit 266 determines whether or not the count time of the timer has reached the predetermined time T3 (step S84). Since there is a possibility of occurrence of an unchargeable state like a case where the power receiver 200M is separated from the power transmitter 100M in a case where an undetected state of the power for charge continues for a long time, the time limit of the predetermined time T3 is provided.

When the switch control unit 266 determines that the count time has not reached the predetermined time T3 (S84: NO), the main control unit 261M returns the flow to step S78. This is for repeatedly determining whether or not the power for charge has been detected until the count time reaches the predetermined time T3.

Furthermore, when the switch control unit 266 determines that the count time has reached the predetermined time T3 (S84: YES), the switch control unit 266 turns on the switch 213 (step S83). As a result, the state is switched to the state where no resonance power flows through the coil unit 211. In a case where the predetermined time T3 has elapsed without receiving the power for charge since the transmission of the power transmission request signal, the power is not received for some reason. Therefore, the state is switched to the state where no resonance power flows through the coil unit 211. The series of processing is performed as described above.

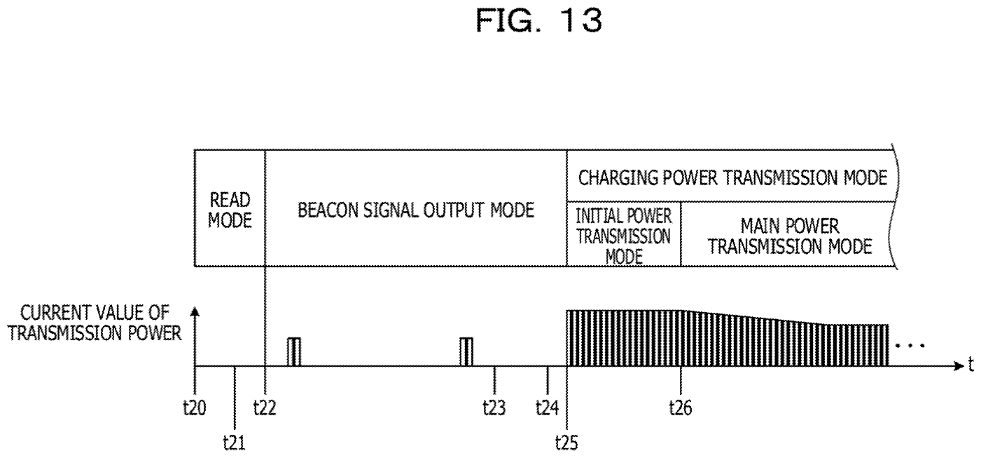

FIG. 13 is a diagram illustrating an operation example of the power transmission system according to the second embodiment FIG. 13 illustrates the modes of the power transmitter 100M, temporal change in the transmission power, and operation timing of the power receiver 200M. Note that the horizontal axis is a time axis.

At time t20, the power transmitter 100M is powered on and starts the read mode.

At time t21, the power transmitter 100M reads the power receiver 200M with the proximity sensor 120M.

By reading power receiver 200M, the power transmitter 100M outputs the beacon signal in the beacon signal output mode at time t22.

At time t23, the power receiver 200M detects the beacon signal. At time t24, the power receiver 200M transmits the power transmission request signal to the power transmitter 100M.

Then, at time t25, the power transmitter 100M is switched to the charging power transmission mode and transmits the power for initial power transmission. The power for initial power transmission is set to a relatively large power to bring the power receiver 200M into the charge state at an early stage.

Furthermore, at time t26, the power transmitter 100M switches the power for initial power transmission to power for main power transmission. This is, for example, a state in which the power transmitter 100M performs data communication with the power receiver 200M and is set to optimal transmission power on the basis of a rated output, a charge amount, and the like of the battery 80 connected to the power receiver 200M.

As described above, when the antenna 270M of the power receiver 200M is held over the proximity sensor 120M, the power receiver 200M is switched to the detection mode of detecting a beacon signal, and the power transmitter 100M outputs the beacon signal. Then, when detecting the beacon signal, the power receiver 200M transmits the power transmission request signal to the power transmitter 100M and is switched to the charge mode. In response to the power transmission request signal, the power transmitter 100M transmits the power for charge to the power receiver 200M.

In other words, the antenna 270M of the power receiver 200M being held over the proximity sensor 120M is the trigger for starting charge.

Here, the power receiver 200M can detect the beacon signal having a predetermined signal strength regardless of the presence or absence of conductors in the surroundings, or the like. The detection of the beacon signal in the power receiver 200M is much more reliable than detection of a charging device by a power transmitter in a conventional power transmission system. This is because the power receiver 200M can detect a minute change in the signal level of the beacon signal, as compared with a change in the load viewed from the power transmitter of the conventional power transmission system.

Then, the power receiver 200M that has detected the beacon signal in the detection mode transmits the power transmission request signal to the power transmitter 100M, and the power for charge is transmitted from the power transmitter 100M that has received the power transmission request signal. Therefore, according to the second embodiment, charge of the power receiver 200M can be more reliably started.

Therefore, the power transmission system, the power receiver 200M, and the method of controlling the power receiver 200M, which are capable of starting charge more reliably, can be provided.

Note that, in the above description, a mode in which the power receiver 200M includes the antenna 270M and the user performs the motion to bring the antenna 270M of the power receiver 200M close to the proximity sensor 120M to cause the proximity sensor 120M to read the power receiver 200M has been described as an example of the predetermined motion to turn on the detection mode of detecting the beacon signal by the user. However, the predetermined motion to turn on the detection mode may be a motion other than such a motion.

Furthermore, in the above description, a mode in which the power transmitter 100M outputs the beacon signal when the antenna 270M of the power receiver 200M is held over the proximity sensor 120M has been described. However, the power transmitter 100M may output the beacon signal before the antenna 270M is held over the proximity sensor 120M.

Although a power transmission system, a power receiver, and a method of controlling the power receiver according to the exemplary embodiments of the present invention have been described in detail, it should be understood that the present invention is not limited to the embodiments disclosed in detail, and various changes and alterations could be made without departing from the scope of claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power transmission system comprising:
a power transmitter configured to transmit power by magnetic field resonance or electric field resonance; and
one or more of power receivers each configured to receive the power transmitted from the power transmitter,
the power transmitter including
a primary-side resonant coil configured to transmit either one of first transmission power that builds a predetermined pulsed beacon signal and continuous second transmission power by the magnetic field resonance or the electric field resonance, and
each of the one or more of power receivers including
a secondary-side resonant coil configured to receive the power transmitted by the magnetic field resonance or the electric field resonance from the primary-side resonant coil,
a processor configured to
execute a motion detection processing that includes detecting a predetermined motion of a user,
execute a mode control processing that includes starting a detection mode of detecting the beacon signal when the predetermined motion is detected by the motion detection processing, and
execute a response signal transmission processing that includes transmitting a response signal to the beacon signal when the beacon signal is detected in the detection mode.

2. The power transmission system according to claim 1, wherein
the power receiver further includes a mode switch for turning on the detection mode, and
the motion detection processing is configured to detect an operation to the mode switch for turning on the detection mode by the user as the predetermined motion.

3. The power transmission system according to claim 1, wherein
the processor of the each of the one or more of power receivers is further configured to execute a proximity communication processing that includes performing proximity communication with the power transmitter,
the power transmitter further includes
a processor configured to execute a communication detection processing that includes detecting the proximity communication of the power receiver, and
the motion detection processing is configured to detect an operation to perform the proximity communication to the communication detection processing by the user using the power receiver as the predetermined motion.

4. The power transmission system according to claim 1, wherein
the power transmitter further includes
a processor configured to
execute a power control processing that includes setting high-frequency transmission power output from a high-frequency power supply to the primary-side resonant coil to either one of the first transmission power and the second transmission power,
execute a reception determination processing that includes determining whether having received the response signal to the beacon signal from at least one of the one or the plurality of power receivers, and
execute a power transmission start determination processing that includes causing the power control processing to set the second transmission power as the transmission power when the reception determination processing determines having received the response signal.

5. The power transmission system according to claim 1, wherein
the processor of the power receiver is further configured to execute a proximity communication processing that includes performing proximity communication with the power transmitter,
the motion detection processing is configured to detect an operation to perform the proximity communication by the user using the power receiver as the predetermined motion,
the power transmitter further includes
a processor configured to
execute a power control processing that includes setting high-frequency transmission power output from a high-frequency power supply to the primary-side resonant coil to either one of the first transmission power and the second transmission power,
execute a reception determination processing that includes determining whether having received the response signal to the beacon signal from at least one of the one or the plurality of power receivers,
execute a power transmission start determination processing that includes causing the power control processing to set the second transmission power as the transmission power when the reception determination processing determines having received the response signal, and
execute a communication detection processing that includes detecting the proximity communication of the power receiver, and
the power control processing is configured to stop the transmission of the first transmission power in a case where the reception determination processing does not detects the response signal within a first predetermined time from when the communication detection processing has started processing of detecting the proximity communication.

6. The power transmission system according to claim 1, wherein the mode control processing is configured to terminate the detection mode in a case where the beacon signal is not detected within a second predetermined time after the detection mode is started.

7. The power transmission system according to claim 1, wherein
the power receiver further includes
a resonant switch that switches a state in which resonance power by magnetic field resonance or electric field resonance flows through the secondary-side resonant coil and a state in which the resonance power does not flow through the secondary-side resonant coil,
wherein the processor is further configured to execute a switch control processing that includes switching the resonant switch to the state in which resonance power flows through the secondary-side resonant coil when the predetermined motion is detected by the motion detection processing.

8. The power transmission system according to claim 7, wherein
the processor of the power receiver is further configured to execute a detection processing that includes detecting the power received by the secondary-side resonant coil, and
the switch control processing is configured to switch the resonant switch to the state in which the resonance power does not flow through the secondary-side resonant coil in a case where the power is not detected by the detection processing within a third predetermined time from when the response signal has been transmitted by the response signal transmission processing.

9. A power receiver comprising:
a secondary-side resonant coil configured to receive power transmitted by magnetic field resonance or electric field resonance from a primary-side resonant coil of a power transmitter;
a processor configured to
execute a motion detection processing that includes detecting a predetermined motion of a user,
execute a mode control processing that includes starting a detection mode of detecting a beacon signal transmitted by the power transmitter when the predetermined motion is detected by the motion detection processing, and
execute a response signal transmission processing that includes transmitting a response signal to the beacon signal when the beacon signal is detected in the detection mode.

10. A method implemented by a processor of controlling a power receiver including a secondary-side resonant coil configured to receive power transmitted by magnetic field resonance or electric field resonance from a primary-side resonant coil of a power transmitter, the method comprising:
executing a motion detection processing that includes detecting a predetermined motion of a user;
executing a mode control processing that includes starting a detection mode of detecting a beacon signal transmitted by the power transmitter when the predetermined motion is detected by the motion detection processing; and
executing a response signal transmission processing that includes transmitting a response signal to the beacon signal when the beacon signal is detected in the detection mode.
